(19) United States
(12) Patent Application Publication
(10) Pub. No.: US 2005/0198059 A1
(43) Pub. Date: Sep. 8, 2005

(54) Database and database management system

(76) Inventor: Peilin Chou, Taipei (TW)

Correspondence Address: TRANSPACIFIC LAW GROUP, 617 NORTH DELAWARE STREET, SAN MATEO, CA, 94401, US

(21) Appl. No.: 10/794,698

(22) Filed: Mar. 4, 2004

(51) Int. Cl. G06F 7/00

(52) U.S. Cl. 707/102

(57) ABSTRACT

The database management system of this invention is used to manage a database of a plurality of data files and comprises: a data file access module to access particular data file to obtain content of said data file, to edit and to restore; an index analyzing module to analyze said content of said data file and generate a series of descriptive data stream comprising indices and weight values; an index establishing module to establish a series of descriptive parameters for said particular data file according to results of analysis of said index analyzing module; a data file searching module to search in said database data files with descriptive parameters similar to a series of searching descriptive parameters; and a user interface to allow users to input, edit and delete descriptive parameters for particular data file.

### FIELD OF THE INVENTION

The present invention relates to a database management system, especially to a database system using a novel data file indexing system and a management system for data files in said database.

### BACKGROUND OF THE INVENTION

In the conventional database management technology, a database in general includes a large quantity of data files. Each data file is defined by or connected by indexes and the database is thus managed by indexing, classifying, searching and accessing the data files based on one or more indexes.

In the conventional database management system, when a user is filing a data file, the database management system will require the user to fill into particular columns descriptive terms of data file. These descriptive terms, along with labels of the columns that they belong, are stored in connection with the corresponding data file. For example, if the data file represents an article, a report for the electronic component market, a user could fill in terms such as “electronic component”, “memory”, “market information”, date etc. as indexes. These terms are stored in connection with the market report. When searching, a user needs only to key in “key words” such as “electronic component”, “market information” or other symbols in particular columns shown in the user interface of the search program of the database management system, data files such as articles labeled or indexed with same key words or indexes will be called out. Effective search of data files can thus be realized.

In such data file indexing system, all these indexes are input manually. Professional knowledge or correct understanding of the content of the articles is very important in ensuring the quality of the indexing. If unfortunately wrong or less descriptive indexes are input due to misunderstanding or prejudice, correct search of data files can not happen. In addition, in the conventional database management system, columns allowing input of indexes are of limited number. As a result, indexers can only choose limited number of “important”, “more descriptive” or “more searchable” terms or symbols as indexes. When one uses a key word to search in a database, articles that are not indexed by that key word can never be searched. Nevertheless, in the conventional technology, indexes are determined manually, not automatically. Computerization of indexing has been a task to many researchers in this field.

In the conventional art, there is another database management system that searches and accesses articles by comparing searching key words with the whole text of the articles. As no indexes are provided or generated, searching of data files is slow and not efficient.

### OBJECTIVES OF THE INVENTION

The objective of this invention is to provide a novel database system and its management system.

Another objective of this invention is to provide a database management system using a novel indexing system.

Another objective of this invention is to provide a database management system using an automatic data file indexing system.

Another objective of this invention is to provide database system with dynamically adjustable indexes and its management system.

Another objective of this invention is to provide a database system indexed with the above indexing systems.

Another objective of this invention is to provide a novel database searching method and system.

### SUMMARY OF THE INVENTION

According to this invention, a database management system is provided and is used to manage a database system with a plurality of data files. The database management system comprises: a data file access module to access particular data file to obtain content of said data file, to edit and to restore; an index analyzing module to analyze said content of said data file and generate a series of descriptive data stream comprising indices and weight values; an index establishing module to establish a series of descriptive parameters for said particular data file according to results of analysis of said index analyzing module; a data file searching module to search in said database data files with descriptive parameters similar to a series of searching descriptive parameters; and a user interface to allow users to input, edit and delete descriptive parameters for particular data file. This present invention also provides a database system that is indexed using the invented database management system.

In this invention, the data file descriptive parameters (Description) may be represented by the following formula:
Description=(a₁,w₁),(a₂,w₂), . . . , (aₙ,wₙ)
wherein Description represents descriptive parameters of a data file, aₙ represents an index, wₙ represents its weight, which denotes influence of the index to the features of said data file.

These and other objectives and advantages of this invention may be clearly understood from the detailed description by referring to the following drawings.

### BRIEF DESCRIPTION OF THE DRAWINGS

FIG. 1 shows the system diagram of the database management system of this invention.

FIG. 2 shows the flowchart of the process in analyzing indexes of a text file using the database management system of this invention.

FIG. 3 shows the flowchart of the process in searching data files using the database management system of this invention.

### DETAILED DESCRIPTION OF THE INVENTION

The database management system of this invention may be used to analyze a plurality of data files to obtain descriptive parameters of the respective data files and to connect results of such analysis to a database containing these data files, such that these data files may be searched based on such descriptive parameters. The database management system of this invention may also be used to analyze content of a particular data file, such that resulted descriptive parameters may be used as key words in searching data files in connection with such or similar descriptive parameters.

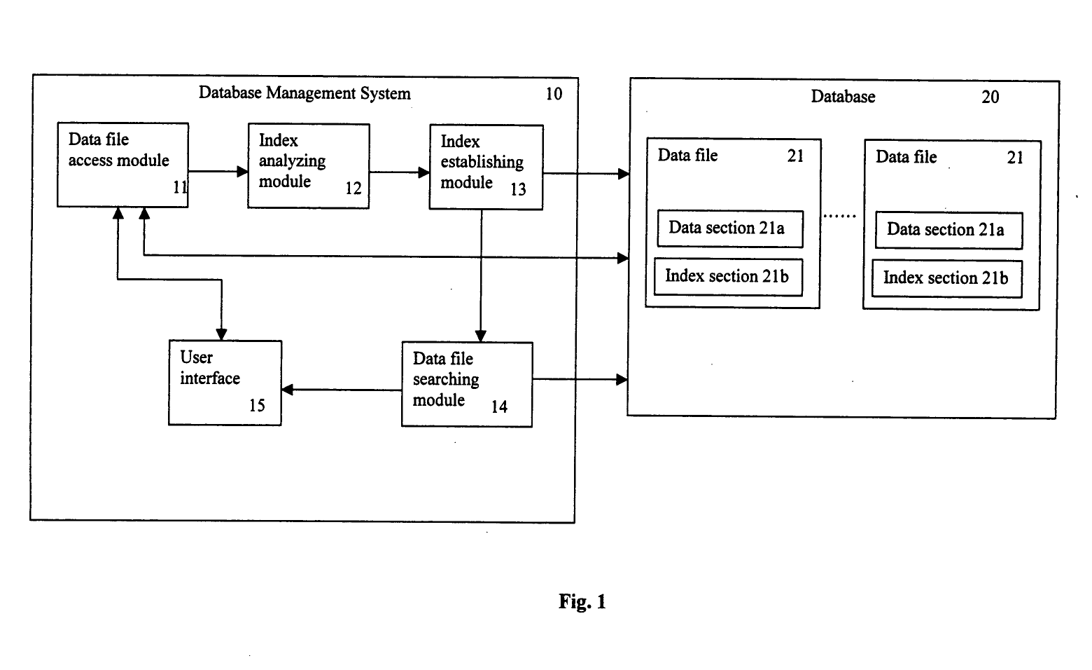

Detailed description of the database system and the database management system of this invention will be given by referring to the drawings. FIG. 1 is the systematic diagram of the database management system of this invention. As shown in this figure, the database management system 10 of this invention is used to manage a database 20. Here, the term “management” includes to classify, index, search and access data files. The database 20 includes a plurality of data files 21. Each data file 21 comprises a data section 21a to include content of the data file and an index section 21b to include descriptive parameters describing characteristics of the data file. The descriptive parameters may be obtained after the data file is processed using the database management system of this invention.

As shown in FIG. 1, the database management system 10 of this invention comprises: a data file access module 11 to access particular data file to obtain content of said data file, to edit and to restore; an index analyzing module 12 to analyze said content of said data file and generate a series of descriptive data stream comprising indices and weight values; an index establishing module 13 to establish a series of descriptive parameters for said particular data file according to results of analysis of said index analyzing module; a data file searching module 14 to search in said database data files with descriptive parameters similar to a series of searching descriptive parameters; and a user interface 15 to allow users to input, edit and delete descriptive parameters for particular data file.

In these modules, the database access module 11 is preferably connected directly to the database 20, such that it can access the database 20 at background. As a result, whenever a new data file is added into the database 20, the database access module 11 may access at any time for processing. After the processing, the data file is added necessary indexes and stored back to particular address of the database 20. In another embodiment of this invention, the database access module 11 accesses and processes newly added data files of the database upon user's instruction.

In addition, it is possible to allow users to input new data files through the user interface 15. The new data files may be for filing purpose or for searching purpose, or both.

A new data file obtained by the database access module 11 will first be converted into a proper data format. The index analyzing module 12 analyzes the content of the data file and generates a series of data comprising indexes and weights of the respective indexes. Data formats applicable in this invention include text, graphics, audio, collection of vectors, collection of symbols, collection of signals etc. Generally speaking, data contained in the data file preferably have a certain level of entropy. The analysis process of the data file analyzing module 12 of this invention will be described hereinafter, taking the analysis of a text file as example.

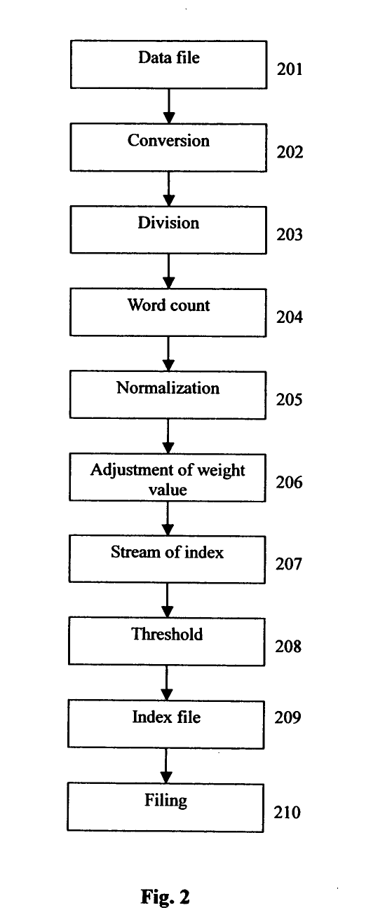

FIG. 2 shows the flowchart of the process in analyzing indexes of a text file using the database management system of this invention. As shown in this figure, at 201 the database access module 11 obtains a data file, which data file is a text file. At 202 the database access module 11 converts the text file into a file of text format. At 203 the index analyzing module 12 divides the whole text file into a continuous stream of “words”. In dividing the text file, there are many technologies available in the market, even if the text file comprises Chinese characters. As dividing the text file is a known art, detailed description thereof is thus omitted. At 204 the word count of every word in the text file is calculated and a collection of “word” and its “word count” is obtain. The words are used as “indexes” of the text file and the word counts are used as bases of “weights” of the corresponding indexes. The collection may be called an “index stream” and represents a data file. Then at 205 normalization of the index stream is processed. Here, the purpose of the normalization process is to eliminate the influence of the length of the text file to the indexes and their weights. In practice, it is possible to determine a standard length for all text files and compare the length of every text file with the standard value. All word counts are normalized using the ratio so obtained.

At 206 adjustment is made to words that have great word count but are of no referential value. In the adjustment, weight or word count of words that would exist in most text files is decreased. In the embodiment of this invention, an IDF (inverse document frequency) value is used to adjust the weights, as follows:
IDF=log(N/Ntx) (2)
wherein N represents number of text file to be processed in a batch and Ntx represents number of text files that contain the word tx.

In the adjustment process, all word counts are timed by the respective IDF values. As a result, the greater number of text file a word exists, the smaller its IDF value is. When the number of text file in which a word exists is very great, its IDF approaches to 0.

After the above steps, at 207 all weight values of the words are obtained and stored. A stream of index and weight for each text file is obtained.

The function of the index establishing module 13 is to select words or indexes that are descriptive to the features of a text file. In the index establishing module 13 a threshold value may be stored. The threshold value may be determined according to past experiments or set manually by user according to particular purpose or past experience. The establishment of the index file will be described by referring to FIG. 2.

At 208 the index establishing module 13 obtains the threshold value. At 209 words or indexes with weight values (or absolute value of the weights) higher than or equal to the threshold value are selected from the index stream to form an index file. In some embodiments of this invention, the threshold value represents number of indexes to be selected. As the threshold value is adjustable, content of the index file is adjustable by user or system manager.

The index file so obtained is attached or connected to the text file by the database access module 11 at 210 and both are stored into the database 20 as an indexed file 21. The index file may also be used as basis of search for the data file searching module 14, to be described in more details hereinafter.

In the above example, the data file is a text file. For anyone skilled in the art, it is known that index files may be established, using the same or similar process, for data files of other format, content and characteristics.

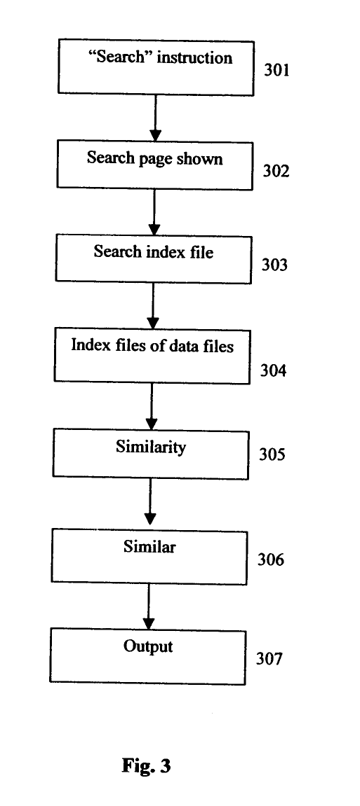

The data file searching module 14 provides users with function of searching data files from the database 20. In searching the data files, a user first inputs, in indexes that the user wishes to use to search for useful data files in the database. FIG. 3 shows the flowchart of the process in searching data files using the database management system of this invention.

As shown in this figure, at 301 the user inputs the “search” instruction. At 302 a search page is shown in the user interface, allowing the user to input searching conditions. In the present invention, the searching conditions include a series of limited number of index and value. The user may key in all possible key words and their weights. In another embodiment of this invention, a look-up-table (not shown) of “concept” and corresponding “indexes” is stored in the data file searching module 14. In the table, a plurality of “concepts” and their corresponding “key words” and their “weights” are provided. User needs only to select any one of the concepts; a searching index file will be generated. The concept-to-index look-up-table may be established by system developer or by user according to past searching experience. Taiwan patent No. 146100 discloses a technology to establish a concept-to-index look-up-table according to determination of user based on past search experience. Such technology may be taken for reference in this invention.

Of course, if no such look-up-table exists in the system, the user interface may provide a plurality of columns allowing user to input key words. The user interface may also automatically generate suggested weight values, allowing user to select. Both can be realized using the conventional technology.

In the present invention, the index file or the descriptive parameters of the index file, as result of index analysis conducted to a particular data file, can be used as search conditions to search desired data files from the database 20. In other words, in step 302 the user does not input a series of search indexes and their weights but a data file which represents the model file of search conditions. The database management system of this invention analyzes descriptive indexes of the data file using the index analyzing method as described above to generate an index file for the model data file. Such index file contains descriptive indexes of its content and the descriptive-indexes may be given to the data file search module 14 to be used as search conditions.

At 303 the system generates or the user inputs a search index file comprising a series of search indexes or key words and their weight values. At 304 the data file searching module 14 calls out all index files attached to the data files of the database 20. At 305 the data file search module 14 compares the indexes and weights of all the index files with that of the search index file to calculate their respective similarity values. Calculation of the similarity value may includes:

Obtaining a search index file represented by the following equation:
Sᵢ=(x₁,wᵢ₁),(x₂,wᵢ₂), . . . , (xₘ,wᵢₘ)

Allocating indexes that are identical to the search indexes (x₁, x₂, . . . , xm) and have a weight value other than 0 in the descriptive file of all data files to obtain descriptive index files, represented by the following equation:
Dⱼ=(y₁,wⱼ₁),(y₂,wⱼ₂), . . . , (yₙ,wⱼₙ)
wherein xₖ=yₖ. And

Calculating similarity between descriptive parameters of the respective Dj files and that of the search index file Sᵢ, as follows:

$$Similarity = {\sum }_{k = 1}^{n} {w}_{ik} \times {w}_{jk} , ∀ {x}_{k} = {y}_{k}$$

After the above calculation, all similarity values are obtained. At 306 data files with similarity values greater or equal to a predetermined value are selected as result of search. The result is then output at 307.

The database management system of this invention is able to generate useful indexes for data files in a database for classification, management and search purposes. In addition, the index files may be established at background at any time. Efficiency in indexing, classification, management and search is thus enhanced.

In the present invention, the user may search desired data files by inputting a series of search indexes or a search concept. The user may also just input a model data file or other data file and the database management system of this invention will automatically generate a search index file and search desired files in the database within a short time. In addition, the system may be designed to collect favorite search indexes during the repeated search of the user. Frequent search indexes may also be collected to generate a search index file, as follows:
Description−of−frequent−search=(a₁,w₁),(a₂,w₂), . . . , (aₙ,wₙ)

The database management system of this invention may use such frequent search index file to search useful data files from the database for the user.

As the present invention has been shown and described with reference to preferred embodiments thereof, those skilled in the art will recognize that the above and other changes may be made therein without departing form the spirit and scope of the invention.

1. A database management system, comprising:
a data file access module to access particular data file to obtain content of said data file, to edit and to restore;
an index analyzing module to analyze said content of said data file and generate a series of descriptive data stream comprising indices and weight values;
an index establishing module to establish a series of descriptive parameters for said particular data file according to results of analysis of said index analyzing module;
a data file searching module to search in said database data files with descriptive parameters similar to a series of searching descriptive parameters; and
a user interface to allow users to input, edit and delete descriptive parameters for particular data file.

2. The database management system as claim 1, wherein said data file is a text file, said indexes comprise “words” contained in said text file and said weight values represents frequency of said words existing in said test file.

3. The database management system as claim 2, wherein said weight values are normalized by a normalization factor IDF, as follows:
IDF=log(N/Ntx)
wherein N represents number of text file to be processed in one batch and Ntx represents number of test files that contain the word tx.

4. The database management system as claim 1, wherein said index establishing module selects, according to predetermined threshold value, indexes with weight values greater than or equal to said threshold value as descriptive parameters of said data file.

5. The database management system as claim 1, wherein said index establishing module selects a predetermined number of indexes with greater weight values as descriptive parameters of said data file.

6. The database management system as claim 1, wherein said data file searching module uses a series of descriptive parameters comprising indexes and weight values to search data files with similar descriptive parameters from said database.

7. The database management system as claim 6, wherein said descriptive parameters are input by user.

8. The database management system as claim 6, wherein said descriptive parameters are generated through analysis of content of particular data file.

9. The database management system as claim 6, wherein said descriptive parameters are generated through analysis of history of search-activity of user.

10. The database management system as claim 1, wherein said data file searching module uses a group of search parameters Dj:
Dⱼ=(y₁,wⱼ₁),(y₂,yⱼ₂), . . . , (yₙ,wⱼₙ)
wherein y represents search index, wj represents its weight value;
to calculate similarity between the group of search parameter Dⱼ and a group of descriptive parameter Sᵢ, as follows:
Sᵢ=(x₁,wᵢ₁),(x₂,wᵢ₂), . . . , (xₘ,wᵢₘ)
wherein x represents descriptive index and wi represents its weight value; and
wherein said similarity is calculated according to the following equation:
$$Similarity = {\sum }_{k = 1}^{n} {w}_{ik} \times {w}_{jk} , ∀ {x}_{k} = {y}_{k}$$

11. The database management system as claim 10, wherein said descriptive parameters are input by user.

12. The database management system as claim 10, wherein said descriptive parameters are generated through analysis of content of particular data file.

13. The database management system as claim 10, wherein said descriptive parameters are generated through analysis of history of search activity of user.
